(19) United States
(12) Patent Application Publication
(10) Pub. No.: US 2004/0252202 A1
(43) Pub. Date: Dec. 16, 2004

(54) Image data processing methods, imaging apparatuses, and articles of manufacture

(76) Inventors: D. Amnon Silverstein, Mountain View, CA (US); Daniel R. Tretter, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/459,080

(22) Filed: Jun. 10, 2003

(51) Int. Cl. H04N 5/228

(52) U.S. Cl. 348/222.1

(57) ABSTRACT

Image data processing methods, imaging apparatuses, and articles of manufacture are described. According to one embodiment, an image data processing method includes providing image data comprising a plurality of frames using an image sensor, and the providing comprising providing the image data of a first frame comprising a first number of parameters, providing the image data of a second frame comprising a second number of parameters less than the first number of parameters, and increasing the number of parameters of the image data of the second frame after the providings.

### FIELD OF THE INVENTION

At least some embodiments of the invention relate to image data processing methods, imaging apparatuses, and articles of manufacture.

### BACKGROUND OF THE INVENTION

Digital imaging devices are becoming increasingly popular for still and video imaging operations. Numerous advancements for these devices have been made including increased resolutions and improved processing speeds. However, some digital video imaging device configurations are limited in resolution and framerate, in part, because of limited bandwidth available for accessing digital image data from an imaging sensor. One possible bottleneck in the data acquisition of some sensor configurations is the analog-to-digital conversion operations.

Some imaging systems have been tailored to accommodate bandwidth limitations. For example, color television provides relatively low bandwidth color information and relatively high bandwidth luminance information inasmuch as the human visual system has relatively low resolution for color information, both spatially and temporally.

Some digital camera systems may not capture luminance and chrominance information independently. Instead, they may capture images in a first format (e.g., RGB) and subsequently transform the captured images into luminance and chrominance information. Additionally, a color mosaic may be utilized to capture a single color at individual pixel locations and the data may be subsequently processed to provide a color image.

In addition, some digital video camera device configurations may not be configured to download subsets of data, but rather require downloading of the entire sensor data in single frames. These camera device configurations may have limited resolution and framerate due to available bandwidth.

At least some embodiments of the present invention provide improved methods and apparatus for implementing digital imaging operations of increased quality at increased framerates.

### SUMMARY OF THE INVENTION

At least some embodiments of the invention relate to digital image processing methods, digital image devices and articles of manufacture.

According to one embodiment, an image data processing method comprises providing image data comprising a plurality of frames using an image sensor. The providing comprises providing the image data of a first frame comprising a first number of parameters and providing the image data of a second frame comprising a second number of parameters less than the first number of parameters. The method further includes increasing the number of parameters of the image data of the second frame after the providings.

According to another embodiment of the invention, an imaging apparatus comprises an image sensor configured to provide image data for a plurality of frames comprising for a first class of frames image data of a first number of parameters for a second number of pixels, and for a second class of frames image data of a third number of parameters for a fourth number of pixels. In one embodiment, the first number is greater than the third number and the second number is less than the fourth number. The apparatus further includes processing circuitry configured to receive the image data and to provide image data for a plurality of additional pixels of the first class of frames, and to provide image data including additional parameters for pixels of the second class of frames.

Other aspects of the invention are disclosed herein as is apparent from the following description and figures.

### DESCRIPTION OF THE DRAWINGS

FIG. 1 is an illustrative representation of an imaging apparatus according to one embodiment.

FIG. 2 is a functional block diagram of an imaging device according to one embodiment.

FIG. 3 is a flow chart of a method of processing image data according to one embodiment.

### DETAILED DESCRIPTION OF THE INVENTION

At least one embodiment described herein utilizes available image sensor configurations which enable independent addressability of pixels and/or color planes to provide video of improved quality including acceptable resolution and relatively high framerate. One embodiment captures color information on a relatively small percentage (e.g., 10%) of video frames (i.e., the first class of frames) with lower bandwidth monochrome information proving sufficient for the remainder of the frames (i.e., the second class of frames). In one embodiment, full color (e.g., RGB) is captured every tenth frame and bi-directional linearly interpolated to add color (e.g., RGB) to adjacent monochrome (e.g., green) frames to provide quality video. In embodiments using RGB to Yc_{b}cᵣ conversion operations, ⅔ less bandwidth is utilized wherein 10% of frames comprise first class frames and the remaining frames comprise second class frames as described in the above example.

Another example is provided wherein a given image sensor is constrained to download no more than 10 M samples per second. At an exemplary video resolution of 640×480 pixels, the full color data from the sensor would be limited to less than 11 frames per second resulting in poor quality video. To achieve a desired framerate of 30 frames per second, the dimensions would have to drop to 60% of VGA (384×288 pixels). Using exemplary embodiments described herein, one frame of 384×288 color data followed by nine frames of monochrome information at full 640×480 resolution would provide improved framerate and resolution with only minor degradation. Accordingly, frames including full color may be obtained at lower resolutions if constant bandwidth is desired.

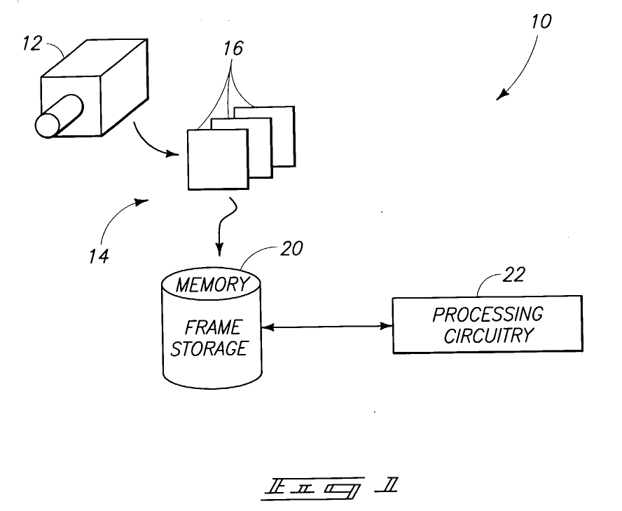

Referring to FIG. 1, an imaging apparatus 10 according to one exemplary embodiment is illustrated. Imaging apparatus 10 includes an imaging device 12, such as a digital video camera, configured to obtain image data 14. Image data 14 includes a plurality of frame images or frames 16 obtained during imaging operations. Individual frames 16 comprise a raster of digital data comprising, for example, luminance, chrominance or other digital information, for a plurality of pixels in a raster.

The illustrated configuration of apparatus 10 further includes a memory 20 and processing circuitry 22. Memory 20 is configured to receive and store image data 14 comprising frames 16. Exemplary memory may be implemented as hard disk memory, random access memory, read only memory, flash memory or other memory arrangements for storing digital data.

Processing circuitry 22 is arranged to process image data 14. Exemplary processing operations of processing circuitry 22 are described in detail below. Processing circuitry 22 may be arranged to execute programming instructions (e.g., software, hardware, etc.) to process image data 14. Accordingly, in such arrangements, processing circuitry 22 may be implemented as a microprocessor of a notebook computer, personal computer, workstation or other digital processing arrangement. Processing circuitry 22 may also comprise a field programmable gate array or any other hardware and/or software configuration capable of processing digital data of the obtained image data 14 as described herein.

Memory 20 and processing circuitry 22 are depicted externally of imaging device 12 and separate in the exemplary configuration. In other possible embodiments, memory 20 and processing circuitry 22 may be embodied within a single device, such as a computer or workstation. In another possible embodiment, memory 20 and/or processing circuitry 22 are arranged within imaging device 12. Other configurations of imaging apparatus 10 are possible.

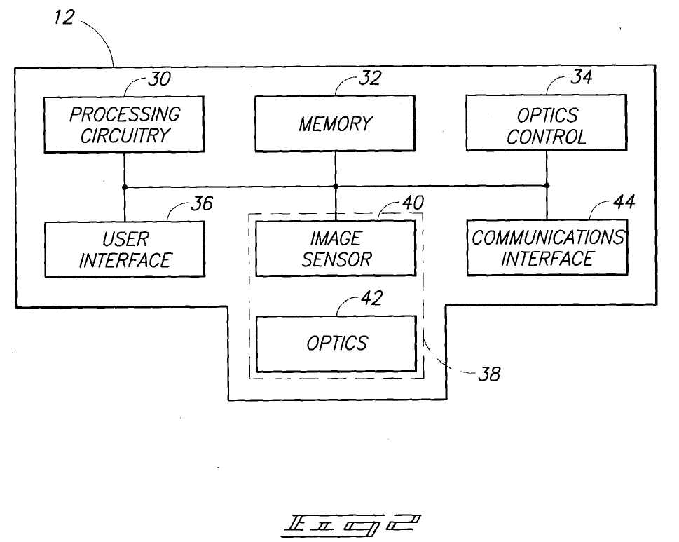

Referring to FIG. 2, an exemplary embodiment of an imaging device 12 is shown. As shown in FIG. 2, the exemplary imaging device 12 includes processing circuitry 30, a memory 32, an optics control 34, a user interface 36, an imaging system 38 (including an image sensor 40 and optics 42 in the exemplary embodiment) and communications interface 44. The illustrated exemplary imaging system 38 is configured to provide raw digital image data in a plurality of frames. The raw digital image data comprises digital data corresponding to a plurality of pixels of raw images formed by image sensor 40.

Processing circuitry 30 is implemented as a microcontroller in an exemplary configuration. Processing circuitry 30 is configured to execute instructions to control operations of device 12 and the generation of image data. Alternatively, processing circuitry 30 may be completely implemented in hardware. Additionally, processing circuitry 30 may control operations of user interface 36 including controlling the display of information using user interface 36 and the processing of inputted data received via user interface 36.

Memory 32 is arranged to store digital information and instructions. Memory 32 may include a buffer configured to receive raw raster image data from image sensor 40 and to store such data for processing. Memory 32 may be embodied as random access memory (RAM), read only memory (ROM), flash memory or another configuration capable of storing digital information including image data, instructions (e.g., software or firmware instructions utilized by processing circuitry 30), or any other digital data desired to be stored within device 12. Memory 20 and processing circuitry 22 of FIG. 1 (or operations thereof) may be implemented using memory 32 and processing circuitry 30 of FIG. 2 (or vice versa) in exemplary embodiments.

Optics control 34 controls focus operations, zoom operations, and/or other desired operations of optics 42. In one embodiment, optics control 34 includes a plurality of motors which are controlled by processing circuitry 30.

Image sensor 40 is configured to generate image data 14 comprising frames 16 responsive to received light. In exemplary configurations, image sensor 40 includes a raster of pixels or pixel locations provided in a plurality of rows and columns. Image sensor 40 may additionally include A/D converters to convert received analog signals into digital image data.

In one embodiment, image sensor 40 is configured to permit independent querying of image data of one or more pixel of the sensor separate from other pixels of the sensor. For example, at a given time instant, any desired or chosen subset of pixels may be read.

In one embodiment, image sensor 40 is implemented using a Foveon X3 image sensor available from Foveon, Inc. The Foveon X3 image sensor comprises a full color sensor which provides full color (e.g., RGB) at a plurality of pixel locations without interpolation. In addition, color information regarding a single color or a plurality of colors may be read from the Foveon X3 image sensor at a given moment in time. The Foveon X3 image sensor may also be configured to implement downsampling, if desired, to provide low resolution image data wherein data is read from less than the total available number of pixels. In particular, the Foveon X3 image sensor permits independent querying of individual pixels or subsets of pixels. Further, an individual pixel may include color information for a plurality of colors and the individual colors may additionally be independently queried or alternately queried with other color information.

In another embodiment, image sensor 40 is implemented using a sensor comprising an array of charge-coupled devices (CCDs) provided in a plurality of rows. Exemplary CCD image sensors 40 are available from Sony Corporation, and have designation ICX282AKF or ICX274AQ, which enables capture of data of selective pixels (e.g., addressing desired rows) or the entire image sensor 40.

A filter (not shown) may be provided between image sensor 40 and optics 42 to implement filtering operations of light received from optics 42 and prior to application of the light to sensor 40. In one example, the filter may be configured to restrict rows of the image sensor 40 to provide information regarding respective single colors. In an exemplary RGB application, the filter is arranged such that one row of pixels of image sensor 40 provides red information, another row provides green information, and yet another row provides blue information and the pattern may be repeated for the remaining rows. Accordingly, if the filter is utilized in combination with the above-described CCD image sensor 40 allowing independent querying of individual rows, frames of image data may be provided which comprise information regarding one, two or three colors. Other filter configurations and image sensor configurations are possible.

Communications interface 44 is configured to implement communication of image data externally of device 12. Communications interface 44 may implement wired or wireless communications in exemplary configurations.

As mentioned above, video images may be limited in resolution and framerate because of limited bandwidth for pulling image data from an image sensor. Exemplary embodiments described herein provide enhanced imaging operations without additional bandwidth requirements.

For example, in one embodiment, imaging device 12 is arranged to generate different classes of frames. One class of frames may include information for more or less parameters than another class of frames and/or information from more or less pixels than another class of frames. Individual parameters may vary depending upon the format of the image data 14 (e.g., color space utilized) and, for example, may include chrominance or luminance information. In an exemplary RGB implementation, individual parameters may correspond to individual colors red, green or blue. In an exemplary CMYG implementation, individual parameters may correspond to individual colors cyan, magenta, yellow, and green (CMYG). In an exemplary Yc_{b}cᵣ format, individual parameters may correspond to chrominance or luminance information.

In one exemplary embodiment, a first class of frames may include color information regarding a single one of plural colors (e.g., red, green and blue), and a second class of frames may: include information regarding more than one color (e.g., three colors red, green and blue). The first class of frames may include information from more pixels than the second class of frames. Accordingly, it is possible in at least one embodiment to provide the classes of frames having a substantially constant bandwidth. For example, a first class of frames may include information for an increased number of parameters compared with the second class, however, the second class may include data from an increased number of pixels compared with the first class.

In a first example, a Foveon X3 image sensor is utilized to provide RGB image data. Frames may be defined as included in groups of ten, or other convenient number. The first frame (or other number) may be in the first class of frames and the second through ninth (or other number) frames may be in the second class of frames. The pattern of first and second classes of frames may be repeated. The first class of frames may capture full color data from a reduced number of pixels (e.g., 60% of VGA or 384 by 288 pixels) while the second class of frames may capture single color data (e.g., green) from an increased number of pixels (e.g., 100% of VGA or 640 by 480 pixels) or vice versa.

In a second example, the Sony CCD image sensor is utilized to provide RGB image data (e.g., in combination with a filter as described above). Frames may be defined as included in groups of ten, or other convenient number. The first (or other number) frame may be in the first class of frames and the second through tenth (or other number) frames may be in the second class of frames. The pattern of first and second classes of frames may be repeated. The first class of frames may capture full color data (e.g., individual rows of pixels correspond to one of red, green, and blue) from a first number of available pixel locations (e.g., all pixels) while the second class of frames may capture data from a reduced number of pixels. In one embodiment, selected rows may be chosen to provide image data for the second class of frames. With the utilization of an associated filter, the rows may be chosen to provide image data of a single color (e.g., green) for the second class of frames.

Processing of image data of the first and second classes of frames may be performed by processing circuitry 22 and/or 30 after the data is captured and quantized (or otherwise digitized), or before digitization using a downsampled image in analog using the Foveon X3 image sensor, for example.

It may be desired to provide fully populated color information at pixels of a desired resolution. In one example, the image data of the first class of frames may be initially processed. If full color information is provided for a reduced number of pixels (e.g., the above-described first example), upsampling may be implemented by processing circuitry 22 to increase the spatial resolution consistent with the second class of frames (i.e., provide a number of pixels of the first class frames corresponding to a number of pixels of the second class frames). For example, intensity information may be averaged or interpolated to provide the upsampling. Upsampling may be omitted if full color data of the first class of frames is otherwise provided at the desired resolution.

Other exemplary processing of the first class of frames includes interpolation by processing circuitry 22 to provide full color information for pixels of the first class of frames (e.g., the above-described second example). For example, if rows of pixels are dedicated to respective individual colors of red, green or blue in accordance with the above-described second example, interpolation may be utilized to populate full color information at an increased number of pixels. Processing circuitry 22 may also increase the number of pixels of the second class frames of the second example having image data. For example, if green information is provided at respective rows of the second class frames, interpolation may be used to provide green information for additional or all rows.

Processing circuitry 22 may also operate to convert image data of the first class of frames from one format to another format. Formats refer to different color spaces (RGB, CMY, CMYK, CMYG, HSB, CIELAB, YCC, etc.) or other representations of color measurement and/or specification. In the exemplary RGB embodiment, processing circuitry 22 may operate to convert image data of the first class of frames to a luminance/chrominance space, such as Yc_{b}cᵣ. A matrix transformation of Matlab, available from MathWorks, Inc., may be utilized to convert RGB data to Yc_{b}cᵣ data and vice versa.

The image data of the first class of frames may be utilized to provide additional or increased image data (e.g., increased parameters) for the image data of the second class of frames. In one embodiment, the converted image data (e.g., Yc_{b}cᵣ data) is utilized. In another embodiment, the format conversion operations may be omitted and the original image data (e.g., RGB data) may be utilized.

Exemplary provision of additional data for the second class of frames uses bidirectional linear interpolation of the image data of the first class of frames providing a weighted average of the image data of the first class frames in proportion to the respective temporal distances of the second class frame of interest from the adjacent (e.g., previous and subsequent) first class frames. In the first above-described example, a frame of the second class is identified. Image data from two first class frames which bound the second class frame of interest may be utilized to increase the image data for the second class frame. In one implementation, nine second class frames are provided intermediate two first class frames. The initial image data of the second class frames may comprise green information in one embodiment. If conversion operations are utilized (e.g., providing RGB data of the first class frames in Yc_{b}cᵣ space), the green information of the second class frames may be equated to the luminance information (Y). Bi-directional linear interpolation of the image data of the two adjacent first class frames may be used to derive additional image data parameters (e.g., weighted average c_{b}′cᵣ′ data) for the second class frames. In one embodiment, the additional image data parameters are provided within the second class of frames using image data parameters initially present in the first class frames and not the second class frames.

In one exemplary bidirectional linear interpolation embodiment, if the second class frame of interest is frame 4, and the next adjacent first class frames are frames 1 and 11, image data of frame 1 may be weighted by a factor of 3 and image data of frame 11 may be weighted by a factor of 7. Then, the weighted image data of frames 1 and 11 may be averaged to provide the interpolated data (e.g., c_{b}′cᵣ′) for the second class frame of interest. Other arrangements are possible for populating image data of the second class frames using corresponding image data of the first class frames.

If desired and following the population of additional image data for the second class of frames, the original and/or added image data for the first and second class of frames may be converted to another appropriate format. In one example, the Y c_{b}′cᵣ′ data of the second class frames and the Yc_{b}cᵣ data of the first class frames may be converted to RGB color space information.

Accordingly, one embodiment provides converting chrominance image data (e.g., RGB) of the first class frame to chrominance and luminance information (e.g., Yc_{b}cᵣ), the interpolating comprises interpolating the chrominance information (e.g., providing c_{b}′ cᵣ′ for the second class frames), and the second converting comprises converting the chrominance and luminance information (e.g., Yc_{b}cᵣ for the first class frames and Y c_{b}′ cᵣ′ for the second class frames) to chrominance information (e.g., RGB).

As mentioned above, conversion operations are optional. If conversion operations are not utilized, the original image data of the first class frames may be bidirectional linearly interpolated to provide additional information at the pixels of the second class of frames. For example, if single color (e.g., green) information is originally provided at the pixels within the second class of frames, color information for other colors (red and blue) may be provided for the pixels of the second class of frames by bi-directional linear interpolation of the original (e.g., RGB) image data.

In one embodiment, image data of pixels of the first class frames are utilized to provide additional image data (e.g., parameters) at corresponding or respective pixels for the second class frames. In another embodiment, motion tracking is utilized by processing circuitry 22 to improve a fit of color interpolation operations. For example, a pixel or a subset of pixels may be identified in an initial frame. Thereafter, the corresponding pixel or subset of pixels may be identified in one or more subsequent frame which determines motion intermediate the frames. The image data of the respective pixels identified by motion tracking may be bidirectional linearly interpolated (or otherwise processed) to provide additional image data for appropriate pixels of the second class frames identified by the motion tracking and using the image data of the first class frames. Exemplary motion tracking operations may be implemented in accordance with a MPEG processing scheme for full motion video.

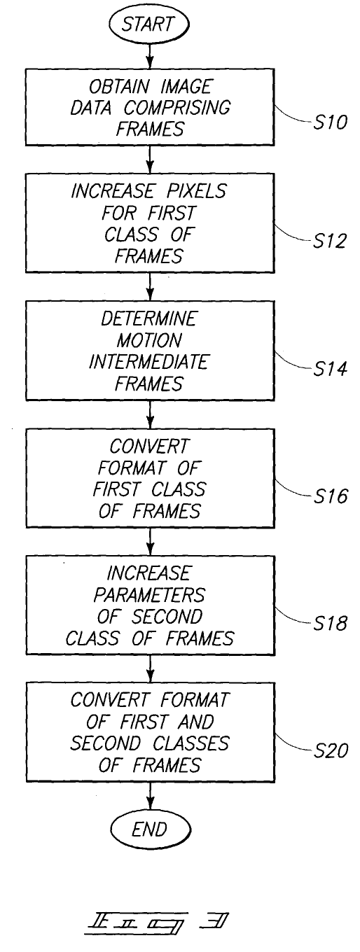

FIG. 3 is a flow chart of an exemplary methodology to implement one embodiment. The methodology may be implemented using hardware and/or programming (e.g., software and/or firmware). In the described embodiment, processing circuitry 22 implements the depicted methodology. In another embodiment, processing circuitry 22, processing circuitry 30 and/or other circuitry implement the exemplary methodology. Other embodiments are possible including more, less, or alternative steps, or using other hardware and/or programming configurations.

Memory of apparatus 10, device 12 and/or other memory includes one or more processor-usable medium configured to store executable instructions (e.g., software, firmware and/or other appropriate processor-usable code or programming). Processor-usable media includes any article of manufacture which can contain, store, or maintain programming for use by or in connection with an instruction execution system including processing circuitry 22 and/or 30 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette such as a floppy diskette, zip disk, hard drive, random access memory, read only memory, flash memory, erasable programmable read only memory, compact disk, or other configurations capable of storing programming.

Referring again to FIG. 3, processing circuitry 22 accesses image data comprising frames from memory 20, memory 32 and/or other appropriate memory at a step S10.

At a step S12, processing circuitry 22 increases the image data for at least some of the pixels for the first class frames. Exemplary increasing includes upsampling (the above-described first example), interpolation (the above-described second example), etc.

At a step S14, processing circuitry 22 determines motion (if any) intermediate the frames being analyzed.

At a step S16, processing circuitry 22 converts a format (e.g., RGB to Yc_{b}cᵣ) of at least some of the image data of the first class frames.

At a step S18, processing circuitry 22 increases parameters of the image data for at least some of the pixels of the second class frames. In one embodiment, processing circuitry 22 uses image data of the corresponding or respective pixels of the first class frames. Alternately, the motion of step S14 is utilized.

At a step S20, processing circuitry 22 converts the format of the image data of the first and second frame classes (e.g., Yc_{b}cᵣ to RGB).

The protection sought is not to be limited to the disclosed embodiments, which are given by way of example only, but instead is to be limited only by the scope of the appended claims.

What is claimed is:

1. An image data processing method comprising:
providing image data comprising a plurality of frames using an image sensor, and wherein the providing comprises:
providing the image data of a first frame comprising a first number of parameters;
providing the image data of a second frame comprising a second number of parameters less than the first number of parameters; and
increasing the number of parameters of the image data of the second frame after the providings.

2. The method of claim 1 wherein the increasing comprises increasing using the image data of the first frame.

3. The method of claim 1 wherein the providing the image data of the first frame comprises providing the image data for a first number of pixels and the providing the image data of the second frame comprises providing the image data for a second number of pixels greater than the first number of pixels.

4. The method of claim 3 further comprising providing image data comprising the first number of parameters for an additional number of pixels of the first frame, and wherein the increasing comprises increasing using the image data of the first frame after the provision of the image data for the additional number of pixels.

5. The method of claim 1 wherein the increasing comprises increasing using image data of the parameters of the first frame not present in the second frame.

6. The method of claim 1 wherein the providing the image data comprises providing image data of a third frame comprising the first number of parameters, and wherein the increasing comprises increasing using the image data of the first frame and the third frame.

7. The method of claim 6 wherein the increasing comprises first converting at least some of the image data of the first frame and the third frame from an initial format to another format, interpolating the converted image data of the first frame and the third frame to provide interpolated data, and second converting the interpolated data from the another format to the initial format to increase the number of color parameters of the image data.

8. The method of claim 7 wherein the first converting comprises converting chrominance information to chrominance and luminance information, the interpolating comprises interpolating the chrominance information, and the second converting comprises converting the chrominance and luminance information to chrominance information.

9. The method of claim 1 wherein the increasing comprises interpolating the image data of the first frame and the third frame.

10. The method of claim 9 further comprising determining motion intermediate the frames, and wherein the interpolating comprises using the determined motion.

11. An imaging apparatus comprising:
an image sensor configured to provide image data for a plurality of frames comprising:
for a first class of frames:
image data of a first number of parameters for a second number of pixels, and
for a second class of frames:
image data of a third number of parameters for a fourth number of pixels, wherein the first number is greater than the third number and the second number is less than the fourth number; and
processing circuitry configured to receive the image data and to provide image data for a plurality of additional pixels of the first class of frames, and to provide image data including additional parameters for pixels of the second class of frames.

12. The apparatus of claim 11 wherein the additional pixels correspond to at least some of the pixels of the second class of frames and the additional parameters correspond to at least some of the parameters of the first class of frames.

13. The apparatus of claim 11 wherein the processing circuitry is configured to utilize image data of the first class of frames to provide the additional parameters.

14. The apparatus of claim 11 wherein the processing circuitry is configured to provide the image data including the additional parameters after providing the image data for the additional pixels.

15. The apparatus of claim 11 wherein the processing circuitry is configured to provide the image data including the additional parameters by interpolating image data of the first class of frames.

16. The apparatus of claim 15 wherein the processing circuitry is configured to convert at least some of the parameters from an initial format to another format, and the interpolating comprises interpolating the converted parameters, and the processing circuitry is further configured to convert the interpolated parameters to the initial format to provide the image data including the additional parameters.

17. The apparatus of claim 15 wherein the processing circuitry is configured to determine motion intermediate the frames, and wherein the processing circuitry is configured to interpolate using the determined motion.

18. An imaging apparatus comprising:
sensing means for providing image data for a plurality of classes of frames; and
processing means for:
accessing image data of a first class of frames comprising a first number of parameters;
accessing image data of a second class of frames comprising a second number of parameters less than the first number of parameters; and
providing image data of an increased number of parameters for the second class of frames after the accessings.

19. The apparatus of claim 18 wherein the providing comprises providing using the image data of a plurality of frames of the first class of frames.

20. The apparatus of claim 18 wherein the providing comprises interpolating the image data of a plurality of frames of the first class of frames.

21. The apparatus of claim 18 wherein the providing comprises converting at least some of the image data of the first class of frames from an initial format to another format, interpolating the converted image data, and converting the interpolated image data from the another format to the initial format.

22. An article of manufacture comprising:
a processor-usable medium comprising processor-usable code configured to cause processing circuitry to:
access image data of a first class of frames comprising a first number of parameters;
access image data of a second class of frames comprising a second number of parameters less than the first number of parameters; and
provide image data of an increased number of parameters for the second class of frames after the accessings.

23. The article of claim 22 wherein the accessing the image data of the first class of frames comprises accessing the image data for a first number of pixels and the accessing the image data of the second class of frames comprises accessing the image data for a second number of pixels greater than the first number of pixels.

24. The article of claim 22 further comprising code configured to cause processing circuitry to provide image data comprising the first number of parameters for an additional number of pixels of the first frame, and wherein the providing comprises providing using the image data of the first frame after the providing of the image data for the additional number of pixels.

25. The article of claim 22 wherein the providing comprises providing using the image data of a plurality of frames of the first class of frames.

26. The article of claim 25 wherein the providing comprises interpolating the image data of the frames of the first class of frames.

27. The article of claim 22 wherein the providing comprises converting at least some the image data of the first class of frames from an initial format to another format, interpolating the converted image data, and converting the interpolated data from the another format to the initial format.

28. The article of claim 27 further comprising code configured to cause processing circuitry to determine motion intermediate the frames, and wherein the interpolating comprises using the determined motion.
